(19) United States
(12) Patent Application Publication
(10) Pub. No.: US 2013/0320700 A1
(43) Pub. Date: Dec. 5, 2013

(54) VISOR EXTENSION DEVICE

(71) Applicants: William Curtis, Vacaville, CA (US); Christopher Curtis, Ocean Side, CA (US)

(72) Inventors: William Curtis, Vacaville, CA (US); Christopher Curtis, Ocean Side, CA (US)

(21) Appl. No.: 13/482,392

(22) Filed: May 29, 2012

(51) Int. Cl. B60J 3/00

(52) U.S. Cl. 296/97.6

(57) ABSTRACT

The present invention is a visor extension device that includes an elongated top piece that has a plurality of rounded edges that has a top surface and a generally rectangular shape and one or more raised edges that are disposed on the top surface and are utilized by a user to horizontally slide the visor extension device across an existing visor of a vehicle. The visor extension device also includes one or more visor clamps that are removably and slidably attached over a top portion of the existing visor to secure the elongated top piece to the top portion of the existing visor and a CD disc holder that is disposed on the top surface of the elongated top piece.

### TECHNICAL FIELD & BACKGROUND

Standard visors that automobiles come equipped with have limited range of motion and are rarely long enough to adequately shield an individual's eyes. Currently there are limited alternatives to a visor which possess an extension with the ability to slide back and forth to suit an individual driver's needs.

The present invention generally relates to an extension device. More specifically, the invention is a visor extension device.

It is an object of the invention to provide a visor extension device that can be attached to an existing vehicle visor and be extended to further protect a driver of a vehicle from sunlight and glare.

It is an object of the invention to provide a visor extension device that has a one piece design that is relatively easier to install and utilize than a traditional visor extension device.

It is an object of the invention to provide a visor extension device that is relatively compact in size and shape.

What is really needed is a visor extension device that can be attached to an existing vehicle visor and be extended to further protect a driver of a vehicle from sunlight and glare that has a one piece design that is relatively easier to install and utilize than a traditional visor extension device that is relatively compact in size and shape.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a front view of a visor extension device, according to an embodiment of the present invention.

FIG. 1B illustrates a rear view of a visor extension device, according to an embodiment of the present invention.

FIG. 1C illustrates a side view of a visor extension device, according to an embodiment of the present invention.

FIG. 1D illustrates a side view of a visor extension device, according to an embodiment of the present invention.

FIG. 1E illustrates a top view of a visor extension device in an extended position, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

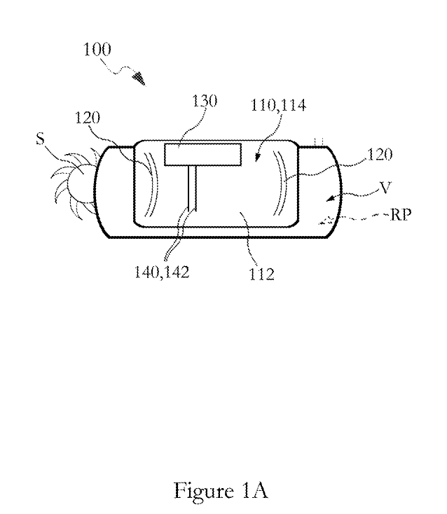

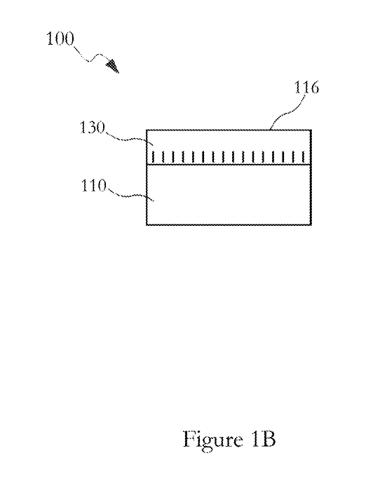

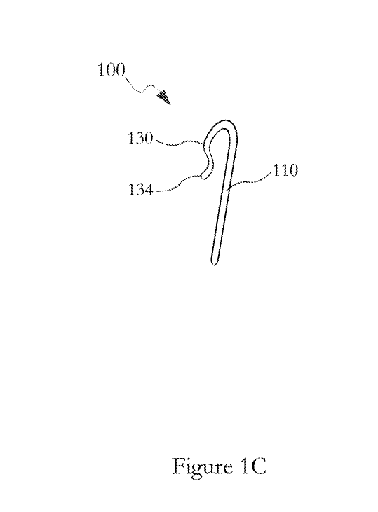

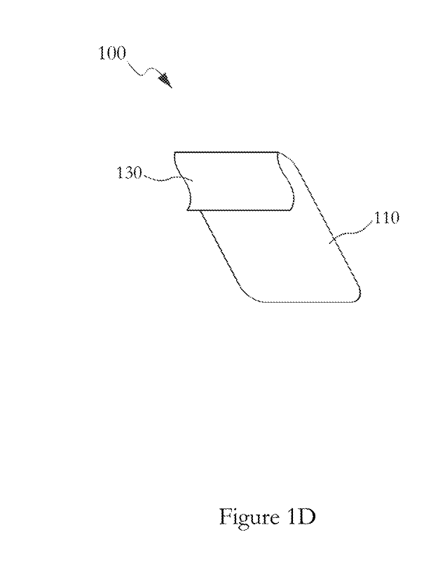

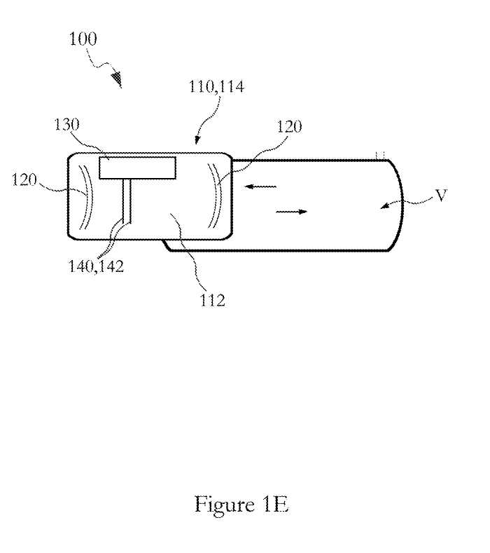

FIG. 1A illustrates a top view of a visor extension device 100, according to an embodiment of the present invention. The visor extension device 100 is removably and slidably attached to an existing visor V of a vehicle such as an automobile or truck and be extended to further protect a driver of a vehicle from sunlight and glare from the sun S. The visor extension device 100 is illustrated in FIG. 1A in a closed position and is made of plastic material, but can be made of any suitable material.

The visor extension device 100 includes an elongated top piece 110, one or more raised edges 120, one or more visor clamps 130 and a CD disc holder 140. The elongated top piece 110 has a top surface 112, a generally rectangular shape 114 and is approximately 6 inches in width and 10 inches in length but can be other suitable dimensions and shapes as well. The one or more raised edges 120 are disposed on the top surface 112 and can be utilized by a user to horizontally slide the visor extension device 100 across an existing visor V of a vehicle. The one or more visor clamps 130 are removably and slidably attached over a top portion TP of the existing visor V to secure the elongated top piece 110 while it is being horizontally slid. FIG. 1A illustrates a single horizontally elongated clamp 132 however the one or more visor clamps 130 can be any suitable quantity, shape or dimension. The CD disc holder 140 can also be disposed on the top surface 112 of the elongated top piece 110. The CD disc holder 140 include one or more internal pockets 142 that are disposed on the top surface 112 of the elongated top piece 110 that can contain one or more CD discs (not shown).

FIG. 1B illustrates a rear view of a visor extension device 100, according to an embodiment of the present invention.

The visor extension device 100 includes one or more visor clamps 130 disposed on a top edge 116 of the elongated top piece 110. The one or more visor clamps 130 are placed over a rear portion RP of the visor V and can be any type of suitable one or more visor clamps as previously illustrated and described in FIG. 1A and its description.

FIG. 1C illustrates a side view of a visor extension device 100, according to an embodiment of the present invention.

The visor extension device 100 illustrated and described in FIG. 1C is similar to the visor extension device 100 illustrated and described in FIG. 1A and includes a similar one or more visor clamps 130 and elongated top piece 110 that is placed over the visor V. The one or more visor clamps 130 has an upturned distal end 134 and have an approximate ¼ inch gap to accommodate the thickness of the visor V.

FIG. 1D illustrates a side view of a visor extension device 100, according to an embodiment of the present invention.

The visor extension device 100 illustrated and described in FIG. 1D is similar to the visor extension device 100 illustrated and described in FIGS. 1A and 1C and includes a similar one or more visor clamps 130 and elongated top piece 110 that is placed over the visor V.

FIG. 1E illustrates a top view of a visor extension device 100, according to an embodiment of the present invention. The visor extension device 100 is illustrated in FIG. 1B in an extended position. The visor extension device 100 has similar elements to the visor extension device 100 illustrated and described in FIG. 1A and its description that include an elongated top piece 110, one or more raised edges 120, one or more visor clamps 130 and a CD disc holder 140.

The visor extension device is made of plastic and is approximately 10 inches in length, 5 inches in height, 1 inch in depth and ⅛ inch in thickness and is afforded a generally rectangular shape with rounded edges. Suitably eliminating sunlight and glare from the sun, the visor extension device is attached to a preexisting visor and extends approximately an extra 5 inches, making driving a vehicle during dusk and dawn relatively safer. The visor extension device incorporates one or more raised edges on the top side which act as a handle to quickly and easily push the extended visor into a plurality of extended and retracted positions. The visor extension device may be readily available wherever automotive accessories can be found in various colors and designs. The visor extension device is versatile enough to be used on any suitable make or model of a vehicle such as any suitable truck or any suitable automobile. The visor extension device is an extendable and retractable addition which protects an individual's sight from the sun and glare while operating a motor vehicle.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A visor extension device, comprises:
an elongated top piece that has top surface and a generally rectangular shape;
one or more raised edges, each defined by an elevated ridge, that are disposed on the interior said top surface, wherein the interior of said top surface is defined by the surface area of said top surface distinct from the outer edges of the rectangular shape, and the one or more raised edges are adapted to be utilized by a user to horizontally slide said visor extension device across an existing visor of a vehicle; and
one or more visor clamps that are configured to be attached over a top portion of said existing visor to secure said elongated top piece to said top portion of said existing visor.

2. The visor extension device according to claim 1, wherein said elongated top piece has a plurality of rounded edges.

3. The visor extension device according to claim 1, wherein said elongated top piece is approximately 6 inches in width and 10 inches in length.

4. The visor extension device according to claim 1, wherein the interior of said top surface includes four discrete raised edges.

5. The visor extension device according to claim 1, wherein the elevated ridge defining each of said raised edges is shaped as an arcuate line.

6. The visor extension device according to claim 1, wherein said visor extension device is made of plastic material and the one or more visor clamps include a upturned distal end.

7. The visor extension device according to claim 1, wherein said visor extension device is approximately 10 inches in length.

8. The visor extension device according to claim 1, wherein said visor extension device is approximately 5 inches in height.

9. The visor extension device according to claim 1, wherein said visor extension device is approximately 1 inch in depth.

10. The visor extension device according to claim 1, wherein said visor extension device is approximately ⅛ inch in thickness.

11. A visor extension device, comprises:
an elongated top piece that has a plurality of rounded edges that have a top surface and a generally rectangular shape;
one or more raised edges, each defined by an elevated ridge, that are disposed on the interior said top surface, wherein the interior of said top surface is defined by the surface area of said top surface distinct from the outer edges of the rectangular shape, and the one or more raised edges are adapted to be utilized by a user to horizontally slide said visor extension device across an existing visor of a vehicle;
one or more visor clamps that are configured to be removably and slidably attached over a top portion of said existing visor to secure said elongated top piece to said top portion of said existing visor; and
a CD disc holder, defined by one or more internal pockets, that is disposed on said top surface of said elongated top piece.

12. The visor extension device according to claim 11, wherein said elongated top piece is approximately 6 inches in width and 10 inches in length.

13. The visor extension device according to claim 11, wherein the interior of said top surface includes four discrete raised edges.

14. The visor extension device according to claim 11, wherein said visor extension device is adapted to be attached to said preexisting visor and extend approximately an extra 5 inches beyond said preexisting visor.

15. The visor extension device according to claim 11, wherein the elevated ridge defining each of said raised edges is shaped as an arcuate line.

16. The visor extension device according to claim 11, wherein said visor extension device is made of plastic material and the one or more visor clamps include a upturned distal end.

17. The visor extension device according to claim 11, wherein said visor extension device is approximately 10 inches in length.

18. The visor extension device according to claim 11, wherein said visor extension device is approximately 5 inches in height.

19. The visor extension device according to claim 11, wherein said visor extension device is approximately 1 inch in depth.

20. The visor extension device according to claim 11, wherein said visor extension device is approximately ⅛ inch in thickness.
